(19) United States
(12) Patent Application Publication
(10) Pub. No.: US 2016/0014176 A1
(43) Pub. Date: Jan. 14, 2016

(54) SYSTEM AND METHOD FOR CONTENT SOLICITATION

(71) Applicant: LiveU Ltd., Kfar Saba (IL)

(72) Inventors: Yoav ARIAV, Kfar Saba (IL); Rafi RAM, Herzliya (IL); Baruch Yosef ALTMAN, Pardes-Hana (IL)

(21) Appl. No.: 14/327,168

(22) Filed: Jul. 9, 2014

(51) Int. Cl. H04L 29/06; H04L 29/12

(52) U.S. Cl. CPC H04L 65/60; H04L 61/609

(57) ABSTRACT

A system and method for content solicitation may include receiving, from a remote data server, a description of a target of interest. The server or a communication device may perform a proximity comparison between a location of the received target of interest and a location of the communication device. Based on the proximity comparison, a processor may operate the communication device to capture media content onto a recording device. The communication device may then transmit the captured media content to a remote content receiving server.

### FIELD OF THE PRESENT INVENTION

The present invention relates to digital content generation, and more specifically, to a system and method for location-based soliciting, indexing and/or distributing real-time digital content from users.

### BACKGROUND

The increase in mobile devices (e.g., smartphones, tablets, camera-equipped glasses, dedicated devices, etc.) operated and owned by consumers has increased the potential availability and demand for newsworthy digital content, including live events in real-time or near real-time. This increase in mobile devices may provide content publishers, such as newspapers or television broadcasters, with more content when events occur, if they are able to access content created by the users of such mobile devices and/or media consumers themselves. Media consumers may create content by providing user-generated content on social media websites, for example, such as live status updates of an event or photos posted to a social media site. However, this content may not be fit for broadcasting and may have limited use by content publishers due to low quality that is available or social media content that is only incidental to an event, for example, media that is initially created for friends but incidentally captures a live, newsworthy event. Further, content publishers' reliance on user-generated content may not capture the full extent of possible content, since not every user in the area of an event is recording or creating content. The gathering of user generated content may be passive, as content publishers may only request content from users after an event has occurred. New ways of generating and consuming media content (live, recorded, edited, sound-only, still images) may be needed which can leverage the proliferation of mobile devices and meet the demand of high-quality and relevant news reporting.

### SUMMARY

A system and method for content solicitation may include receiving, from at least one remote data server, a description of a target of interest. The server or a communication device may perform a proximity comparison between a location of the received target of interest and a location of the communication device. Based on the proximity comparison, a processor may operate the communication device to capture media content onto a recording device or a live stream or TV output. The communication device may then transmit the captured media content to a remote content receiving server.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic diagram of a content solicitation system according to embodiments of the invention;

FIGS. 2A and 2B are schematic flow diagrams of content solicitation methods between a user device and a server according to embodiments of the invention;

FIG. 3 is a schematic depiction of a graphical interface for content solicitation application on a communication device according to embodiments of the invention; and

FIG. 4 is a flowchart of a method according to embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

Embodiments of the invention may include an article such as a non-transitory or non-volatile computer or processor readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein.

User generated content may be content created by regular media consumers or owners of recording devices, capturing devices, streaming devices, or devices equipped with or associated with such capabilities. In embodiments of the invention, “recording”, “capturing” and “streaming” devices may be used interchangeably to refer to all devices with any such one or more capabilities, alone or together. Similarly, the related verbs and other nouns are used interchangeably (e.g., “to record” may also include “to capture”). The recording devices may be mobile devices or may be a part of mobile devices, such as digital cameras in mobile phones. Alternatively, recording devices may be standalone, such as a security camera, and may still be controllable or connectable to a mobile device or phone. User generated content may typically be produced by non-professionals, e.g., people who are not professional journalists, broadcasters or media producers.

Embodiments of the invention may solve various problems with gathering or collecting user generated content. Instead of (or in addition to) passively and retroactively requesting content from users after an event has occurred, embodiments of the invention may enable a system to allow a content publisher to proactively approach or request one or more users (or their devices directly) to record, capture, and transmit or upload content substantially in real-time when a newsworthy event occurs, and to streamline delivery and broadcasting of the content. In other embodiments, a request to provide content by a user on-location may be matched with the need of the content provider for the requested content, and then the user may reject or accept and handle this content. The request may remind or request users to begin using recording or media capturing devices on their phones, for example, in order to record or document relevant information and footage of a newsworthy event. By actively requesting relevant content from users, broadcasters or content publishers may reduce the need to edit or discard irrelevant parts of a video. By using location determination capabilities, time and clock capabilities, IDs such as IMSI or application license ID or others, network related information etc on the users' devices, the publisher can obtain verification of authenticity of the content, of the user, of the event, or some or all of the above. Such authentication of the video of an event may be vital for non-affiliated, citizen/consumer content generation; even with professional content providers, authentication may be required in order to avoid fabrication of content or usage of pre-recorded non-relevant material, or other fraudulent or manipulative content generation or re-use, for example. The system may also respect users' privacy by providing different kinds of permissions and requests, prior to recording or transmitting content, for example, or by requesting permission from a user prior to transmitting location information.

Embodiments of the invention may combine a central system controlled by, for example, a content publisher and end-user software or devices, owned or used by mobile device owners or users. The system and method described herein may use over-the-internet streaming and cloud services to allow one or more content publishers to prompt, notify, and/or alert users or communication devices for requested media content from anywhere in the field, as an event occurs. The system and method may allow users or devices to accept the solicitation of content, record media content, and transmit the recorded or live media content to the central system (e.g., a server owned by the content publisher). The content publisher may then use or edit the received media content for later or instant publishing or broadcasting. Media content captured or recorded by users may include video, photos, sound recordings, metadata, and/or live status updates (for example, status updates to Facebook or Twitter). The system and method may be compatible with video management systems which consider a variety of integrated data sources and manage and prepare various content streams for live transmission, including converting and routing content to standard broadcasting transmission formats.

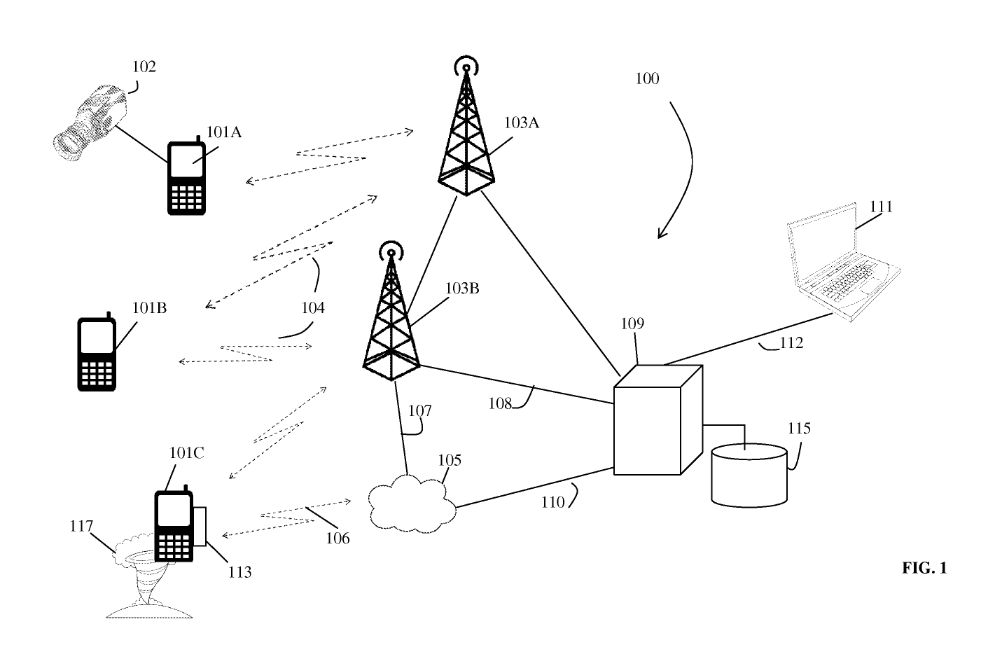

FIG. 1 is a diagram of a content solicitation system 100, according to embodiments of the invention. A plurality of communication devices 101A, 101B, and 101C (collectively referred to as devices 101) may be connected to one or more wireless networks. For example, devices 101 may be connected (e.g. through a wireless connection 104) to a cellular network, e.g., 3G, 4G, LTE, GPRS, or other similar cellular data network via base station 103. Additionally or alternatively, devices 101 may be connected to the internet 105, for example, via a wireless access point communicating in accordance with one or more of the IEEE (Institute of Electrical and Electronics Engineers) 802.11 protocols (e.g., Wi-Fi connection 106). Each of communication devices 101 may include a processor and a non-volatile a computer readable medium having stored thereon a set of instructions executable by the processor to perform the steps described herein. The communication devices may be mobile phones, smartphones, tablets, modems, transmitters, transceivers, or other computing devices capable of connecting to a data communication network and exchanging data with a remote server. Communication devices 101 in communication with a base station may also have access to the internet 105 via the cellular network (for example, through a wired connection 107 from base station 103B to internet 105). Communication devices 101 may include, be associated with, or otherwise control one or more recording or media-capturing devices 102, e.g., a still or video camera or a microphone, and may be capable of recording media content, such as photos, videos, and/or audio recordings, or capturing media content and streaming it. Communication devices 101 may be integrated with a media-capturing device on one device (e.g., device 101C) or communication devices may be associated with a remote media-capturing device 102 by controlling or sending commands to media-capturing devices. Communication devices 101 may also include an encoder, to compress the video prior to recording and/or transmission, such as in H.264 or H.265 or VP9 video encoding standards, or others encoding standards. Communication devices 101 may be capable of determining information pertaining to their geo-location, for example, using Global Positioning System (GPS) or based on the identity of a proximate wireless access point (AP). A content publisher, such as a news organization, television broadcaster, blog, or social network, may access or communicate with the plurality of communication devices 101 by sending alerts, messages, or requests through a central server 109. Central server may be connected to the cellular network 103 (via connection 108) and/or internet 105 (via connection 110). Central server 109 may act as a remote data server or centralized management system, operated by the content publisher or a third party that operates with a group of one or more content publishers. Central server 109 may be a standalone server dedicated to high performance data transfer and storage, and may run suitable software such as Apache HTTP Server or Apache Hadoop. Content publisher may control communications and/or access data on central server 109 and/or associated content receiving server 115 via a user interface, for example, running on computer 111 connected to central server 109 (via connection 112). Other connections and interfaces between devices, base stations, servers, and the Internet may be possible.

A transmitter of the communication device may use bonding, e.g., using multiple cellular or other wireless or other networks, connections, transmitters, modems, technologies to transmit the media to its destination. This bonding may duplicate or split the video data between several of these connections, so that each of the connections carries part of the data in packets. For example, video data from communication device 101B may be split up or duplicated and sent to base station 103A and 103B. The video data may be reassembled at the receiving side, e.g., at the central server 109.

According to some of the embodiments of the invention, when a newsworthy event is occurring, for example, a severe weather storm, terrorist attack, parade, or celebrity sighting, content publisher may use system 100 to request and obtain user generated content from users of mobile devices in the vicinity or proximity of the newsworthy event. The user generated content may provide different perspectives and vantage points of an event beyond what a content publisher's typical reporting resources may be able to capture. In other cases, user generated content may provide footage of an event before a journalist from the content publisher is able to travel to the event. For example, a user in Spain may capture or record content on a terror attack on Americans in Spain and transmit the content to an American content publisher. In operation, the content publisher may enter a target of interest or description of the event or other requested content to the central server 109, including for example, time and/or location information of the device, type of media desired, subscriber ID, application license ID, bio-identity data, cellular network related information such as cell ID, LAC, network ID, DRM (Digital Rights Management) related information etc, or other information or metadata. The target of interest information may also include a textual description, e.g., “Thanksgiving Day Parade on 6^{th} Avenue, New York, New York”, “Explosion at Oil Refinery in Waco, Tex.”, “Severe thunderstorm and tornado warning in central Kansas for Jun. 9, 2014” or “Justin Bieber Spotted in Las Vegas Nightclub”. The central server 109 may receive location and other information from communication devices 101, and may allow a content publisher to apply filters for relevant or quality media content. Content publisher may access data on central server 109 directly, or for example, using a website or interface accessible by computer 111 to control or select criteria for the filters.

Processors associated with communication devices 101 may execute software, such as a mobile application or “app”, rendering it capable of communicating with central server 109. The processor may receive the description of an event or target of interest from the remote data server, or central server 109, including, for example, a textual description of the event or target of interest, a geo-location of interest, a distance radius of relevance, a time of interest, a time window of relevance, etc.

A proximity comparison between a location of the received event or target of interest and a location of the communication device 101 may be performed. In some embodiments, the proximity comparison may be performed by the processor associated with communication device 101. In other embodiments, the proximity comparison may be performed by central server 101 if it receives information describing the location of the communication device 101. The comparison may produce a parameter, e.g., a physical distance (e.g., meters) or a time of travel to the destination. In some embodiments of the invention, a positive result may be returned if the physical distance between the location of the communication device and the target of interest is less than the radius of relevance, other distance measure (e.g., time to arriving at the target of interest), or another predetermined distance threshold. The threshold distance or radius of relevance may be static, may be based on the type of event (e.g., a celebrity sighting event may have a smaller radius or relevance than a terrorist explosion), or may be dynamically changing based on environmental factors such as the density of users in the target's area. In some embodiments, the central server may not have a predetermined distance threshold, but may accept submissions from multiple users and rank them by distance. The central server may further determine ranking based on other parameters or factors, such as media quality, angle, viewability, transmission quality, cost of the transmission, price requested by content provider, monetization options, social network parameters of that content providers (such as number of Facebook friends), stability of the transmission, latency of the transmission, credibility of that content provider according to prior engagements or publicly or other available data about the user or about the user's device. In some embodiments of the invention, a positive result may be returned if the travel time between the location of the communication device and the target of interest is less than the time window of relevance or another predetermined threshold. In some embodiments, the central server may not have a predetermined time threshold, but may accept submissions from multiple users and rank them by closest time to the event. Any other filtering, ranking, ordering, selection or solicitation may be performed. As noted above, these calculations may be performed by the communication device or at the central server based on data provided by the communication device.

Based on a positive result of the proximity comparison, the processor of the communication device may, through the app, operate the communication device to capture media content onto a media-capturing device 113. The media-capturing device 113 may be integrated with the communication device, e.g., a digital camera that is part of a smart phone, or separate but controlled by the communication device, e.g., over a wired or short-range wireless connection (e.g., Bluetooth), or over a network (e.g., a surveillance camera). The processor may operate the communication device to capture media content. In some embodiments of the invention, a user of the communication device may be prompted to grant permission to the mobile app to operate the capturing or recording device, and such permission may be required before the recording device captures content. Permission may be granted on a per-event basis, or may be pre-set earlier by the user, for example, when installing the software.

The mobile communication device may then transmit or upload the captured media content to a remote content receiving server 115. Such transmission may utilize bonded transmission as explained above, or single connection transmission as is more common with current smartphone or WiFi devices. The remote content receiving server 115 may include a processor and associated memory for executing database or other video storage software, and may further be associated with data storage to store the received content. Content receiving server 115 may be in a location separate from central server 109 or may be part of the same system as central server 109.

In one example, a content publisher may request information or media about a target of interest, such as a tornado 117 in a town in Kansas. The content publisher may produce a request including the GPS coordinates of the target of interest, or a range of GPS coordinates or other location information, and optionally, time of interest, and a text description of the target of interest. The request may be transmitted to one or more communication devices 101 via central server 109. In some embodiments, the request may be broadcast to all subscribers. In other embodiments, the request may be sent only to devices already known to be within an area that includes the target of interest, for example, based on a recent communication via a base station in a vicinity of the target of interest.

In other embodiments the request may be sent far in advance of the occurrence of an event. For example, the communication device may receive from central server 109 and a list of potential events which that content publisher may be interested in and store the list in memory. A user of a communication device may subscribe to some of the events on the list, such as “hurricane” or “shooting”. The communication device may use its own or associated sensors to identify probability or occurrence of such an event, or the user may identify it. The user, via the communication device, may be prompted or alerted to the subscribed event and the content publisher may also be alerted that such content is available from the user. Depending on the device and sharing settings and recording parameters of the device the content publisher and user may decide to “accept” this match and allow capturing or recording of media.

A proximity or distance comparison may be performed for each of the communication devices 101 receiving the request, by processors associated with the communication devices 101 or by central server 109. In the example depicted in FIG. 1, communication device 101C may be determined to be sufficiently proximate to the tornado 117. Based on this positive result of the proximity comparison, a user of communication device 101C may be notified, for example, by an alert or by a request to begin capturing media content, such as recording or streaming video or transmitting high quality audio/video (A/V). The captured media may then be transmitted to the central server 109 and/or to content receiving server 115, so that it can be recorded, stored, archived, edited and/or broadcast by content publisher. In other embodiments, capturing media may begin automatically by communication device 101C, and the alert or request may inform the user of transmitting the captured media. Other combination of alerts and requests may be possible.

Computers and devices 101, 109, 115, 111 may be, for example, personal computers, workstations, smartphones, simple terminals, or other sorts of computer systems, and may include components and capabilities other than what is shown in the examples provided. Computer systems such as devices 101, computer systems 111, and server 109 and database 115 may carry out embodiments of the present invention. For example, processors or controllers may collectively or individually be configured to carry out embodiments of the invention by, for example, executing software or code stored for example in memory.

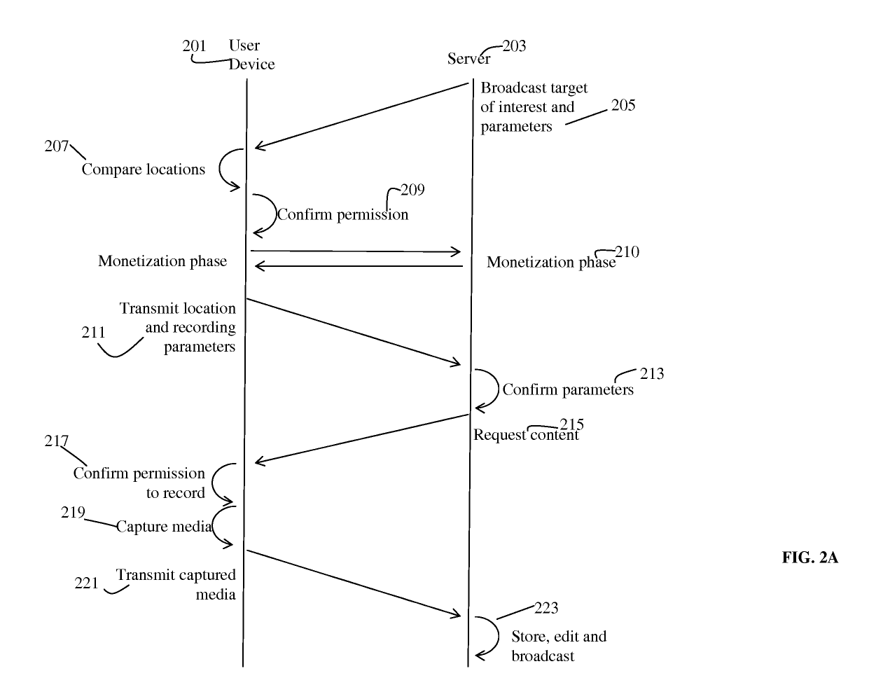

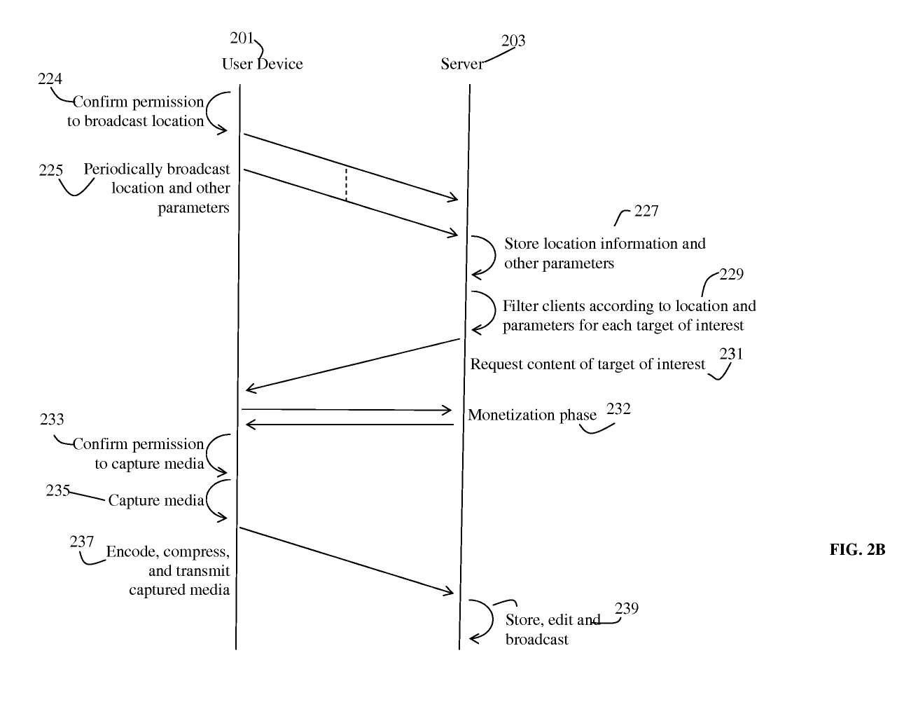

FIGS. 2A and 2B are flow diagrams of a content solicitation method between a user device 201 and a server 203, according to embodiments of the invention. A user device may be, for example, a communication device (e.g., communication device 101 in FIG. 1) including a processor and non-volatile memory executing software capable of communicating with content solicitation server 203. Server 203 may be, for example, a remote data server that is not located near user device 201, such as central server 109 in FIG. 1. User devices may include hardware and software that provide the ability to record media content, such as video or photos. User devices 201 may have the option of only responding to requests for content by a server 203.

In FIG. 2A, the server may periodically broadcast targets of interest and parameters to one or more user devices on communication devices (205). The broadcasted targets of interest and parameters may be messages that describe events and requested types of content, as described above. The messages may be any one of operating system notification alerts (e.g., iOS notification alerts on Apple iPhones or Android Notification Alerts on phones running the Android operating system, SMS (Short Message Service), Skype messages or calls, phone calls, e-mails, social network communication, messaging app communication, or proprietary messaging protocols). The messages may indicate, for example, that a content publisher is requesting recorded video of a concert at Madison Square Garden, for example, or may request photos of a shoe sale on the 3^{rd} floor at Macy's. The messages may further indicate a monetary reward for users who successfully capture requested media. The messages may include specific location information such as a street or building floor.

When the message is received, the user device software may compare a location of the user device with a location of the received target of interest (207). Other determinations may be made, for example, relating to device capabilities, connection parameters, etc.

Based on a positive result of the proximity comparison, if permission has not previously been granted, the user device may confirm permission to transmit location information and other information about the communication device, such as parameters indicating the recording or capturing capabilities, etc. (209). In some embodiments, a user may confirm a specific request to the user sent by the server, or the user may pre-set permission to send location information. Direct user selection by the server may occur, for example, if sufficient geo-location information for the user or user device is not available, such as inside a reception-poor building, or if the user specifically desires a request from the server.

In other embodiments, the server may receive requests for live or recorded video from the same event, marked by a substantially similar geo-location (e.g. requests within the same area of interest or other definition of “same event”). It may then either prompt one or more different users for each of the requests, according to any parameters including quality, user bid price, or willingness to pay from each content distributor who requested the video, for example. The server may forward or resell the same content to several of the content distributors and charge each of them using the same or different pricing. The server may also filter the requests passed to the user, for example, by forwarding a single request representing all duplicate requests known at the time, or it may advise the user that his content now goes to more or less content distributors. It may further inform the user of such new requests and let the user decide on the subsequent action (e.g., whether to record or upload). Similarly, at the user device itself, if several requests from same or different content distributors are received, the software automatically filter the requests based on whether requests are substantially duplicative, whether a new request includes a bid by the content distributor (or server) at a significantly lower price than the current ongoing price the user is receiving. Further the user device may prompt the user for action: for example, the user may decide to accept, order, filter, rank, or prefer requests from preferred requesters or otherwise preferred proposals (price, matching to device, matching to transmission conditions, demands from user, or other parameters).

The user device and server may engage in a monetization phase (210), where both the user device and server may communicate and exchange messages in order to reach an agreement on how a content publisher may pay for user-generated content from the user device. For example, a user or a content publisher or publishers may offer a price for the content or the publishers may pay the users rewards or money. Payments for content may be money, credits to stores, or other benefits. These payments may be agreed upon previously (e.g. a certain amount of money for every minutes at a certain video quality for certain types of events), or the payments may be negotiated in real time. The negotiation may include bidding, offering, accepting, auctioning to or between one or more content publishers or one or more users. The monetization phase (210) may occur at any time prior to transmitting captured media (e.g., right before transmission or prior to a server's broadcasting of a target of interest and parameters (205)).

The user may transmit location or capturing parameters, network parameters (e.g. LAC, network ID, cell ID, technology etc), transmission related parameters (such as bandwidth, latency, transmission stability), other sensor information (raw or processed, such as movement, directivity, humidity, radiation levels, etc) to the server (211). Recording parameters may include, for example, type of recording device(s) available (e.g., resolution, high definition, etc.), nature of data communication (e.g., channels, bandwidth, etc.), type of device, etc.

The server may confirm or authorize that the user device's location and recording parameters are adequate for capturing the particular target of interest (213). For example, the content publisher may decide that a sports event may require certain or sufficiently high bandwidth connection, or a video recording speed, and may previously store these parameters at the central server in association with a target of interest for comparison with responses received to the request. The central server may store information about subscribers and/or devices, such as user or device profile information, e.g., a user's ranking, credibility, and past performance, and whether other content publishers have used the user's previous contributions. The parameters may also include the user's social media feeds or activities. In some embodiments, the server may mine the user's, or any user's or crowd of users' social media activity and information for indications of a newsworthy event, and may automatically trigger one or more events of interest or targets of interest, allowing that user and others to capture and upload content in the vicinity of the events or targets of interest. For example, the server may be able to detect a high occurrence of specific or unusual hashtags in a user's Twitter or Facebook feed, and automatically determine that a target of interest may develop soon. Alternatively, the server may receive information about possible newsworthy events from third parties or third party software, and allow users to capture or record media based on the information from third parties.

The server may then request the user to record or capture content pertaining to the target of interest (215). If, for example, the user's settings allow automatic capturing of media, the notification may serve to alert the user that recording or capturing will begin. The notification may also have an opt-out option, where a user may interrupt recording or prevent recording from starting. In other embodiments, the notification of the target of interest may be in the form of a request to record or capture media content.

In some embodiments, the user may affirm or grant the request and confirm that the communication device has permission to record (217). Thus, the user may confirm permission to record content through automatic permission settings or by a user's specific acceptance of a request or prompt.

The recording device associated with the user may capture media by allowing the user device access to recording software, or by starting a recording program (219).

The user device may then transmit the captured media to the server (221), and the server may store, edit, and broadcast a form of the captured media as part of its reporting on a news event (223).

In another embodiment, shown in FIG. 2B, the user device may confirm permission to broadcast its location to server (224). Permission may be confirmed through pre-loaded permissions settings stored in memory or through a request or prompt to the user to allow or grant permission to broadcast.

The user device may periodically broadcast its location and other parameters such as the strength of connection to a base station or Wi-fi base station, or the amount of battery power left in the user device's device (225).

The parameters and location information may be stored by the server, according to the user device ID, in a table, hash table, linked list, or other data structure (227).

A content publisher may filter through the most relevant users, content sources, or devices for each event or target of interest according to the user device locations and quality of recording devices (229). For example, for a concert at Madison Square Garden, the server can filter through users and select devices that have sufficient battery power and disk space for a thirty second video clip and that have indicated presence within Madison Square Garden. Content publishers may set specific criteria for a remote data server to select one or more remote communication devices based on, for example, the last known or broadcasted location of said device, estimated location of said device, content capturing properties of the device (e.g., whether a device can capture high-definition video), or transmission properties of said device (e.g., whether a device is connected to cellular data service or Wi-Fi).

The server may notify the user device if it is one of the selected devices that match the criteria for a particular target of interest and request content (231). As explained in connection with FIG. 2A, the notification may serve as an alert to a user that the user's communication device will begin recording, or may be a request or prompt asking the user for permission to begin recording media content.

The user device and server may engage in a monetization phase (232), where, as explained in FIG. 2A, the user device 201 and server 203 may communicate and exchange messages in order to reach an agreement on how a content publisher may pay for user-generated content from the user device. The monetization phase (232) may be in real-time or may occur through a prior user agreement, for example. The monetization phase (232) may allow renegotiation of payment for user-generated content, even after a user device has transmitted content to a server.

The user device may confirm permission to capture media (233), by referencing the user device's permissions settings or through a user's acknowledgment after receiving the request for content (231). The user device may capture media onto an associated recording or capturing device (235), encode, compress, and transmit the captured media to the server in accordance with applicable protocols (237). For example, encoding and compression may occur according to video, image, or sound recording compression techniques, such as by H.265, VC-2, MPEG-4 or other similar standards. Prior to transmission, server may further authenticate the user by exchanging password, usernames, keys, or other information. The server may store, edit and/or broadcast the content upon receipt (239).

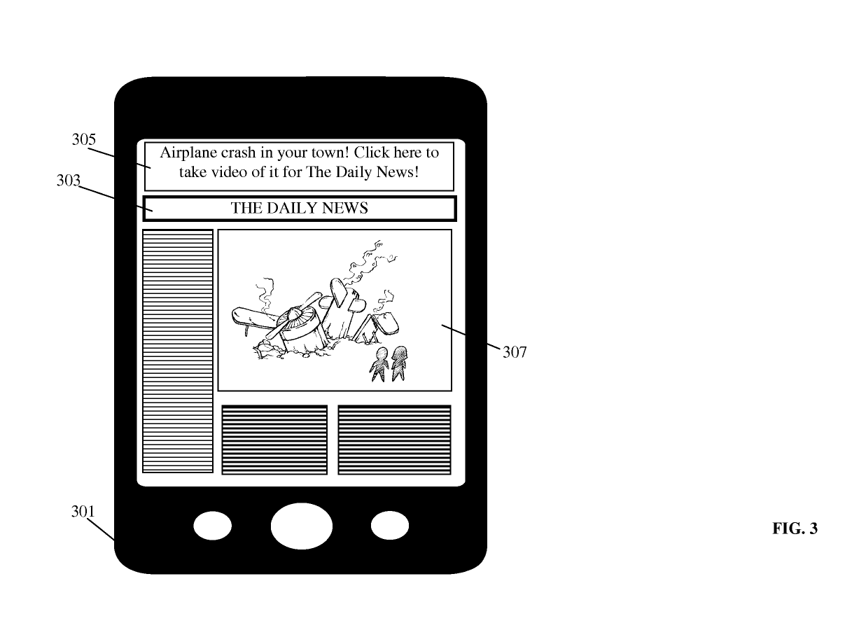

FIG. 3 is a schematic depiction of a graphical interface for content solicitation application on a communication device according to embodiments of the invention. A communication device 301 may include an app or mobile application 303 produced by a content publisher, such as a newspaper or news website. The application 303 may also be connected to a server that provides notifications 305 or alerts of events or targets of interest (e.g., a plane crash 307) for which a content publisher is requesting media content from a user of communication device 301. The notification 305 may solicit or request content from the user, based on a proximity comparison between a location of the target of interest and a location of the communication device 303. If the processor of the communication device 303 or the server determines that communication device 301 is sufficiently or adequately near the target of interest 307, the server may send notification 305 to communication device 301.

Whether a communication device 301 (or alternatively, a media capturing device associated with the communication device) is adequately or sufficiently near the target of interest 307 may be determined dynamically, based on a density of users located in an area, for example. If there are 100 users within a proximity, distance, or radius of 100 m from a target of interest 307, then nearness may then be more narrowly defined than if only five users are in a 100 m vicinity. In other words, for a greater density of people in an area of interest (e.g., an area around a target of interest), a server may alert or solicit media content from user devices in an area that is nearer to the target of interest 307. Conversely, for lesser density of user devices in an area of interest, a server may alert or solicit media content from user devices further away from the target of interest 307. If a density of users or their recording capabilities change or if other environmental changes occur, the proximity comparison may use a different distance threshold to determine nearness. For example, if at a later time fewer users or content generators are in the proximity or vicinity of an event, the threshold distance for a proximity comparison may change, while also taking into account other parameters such as quality of video received from any portion of the users or devices, stability of transmission, angle of interest, or other factors. Further, proximity or area of interest may also be defined by a direction or point of view that is more appropriate for viewing and video capturing (e.g., instead of a radial distance from a target of interest). For example, an area of interest or proximity threshold may be defined as a 500 meter distance from a target of interest in one direction because, for example, a building can be viewed from one direction but not from another. More than one direction may be chosen. In another embodiment, a server may prefer user generated content by users transmitting using a specific list of cell ID's (or BTS ID), or Wi-Fi IDs, since it may be known, or calculated, that the BTS ID has greater transmission capacity or QoS assurance probability, respectively. In other embodiments, the server may create filters based on other parameters sent to the server by communication device 301. If communication device 301 is not near the target of interest 307, or if it does not meet the criteria of filters set by the server or content publisher, the server may not send notification 305 and it will not appear in the application 303.

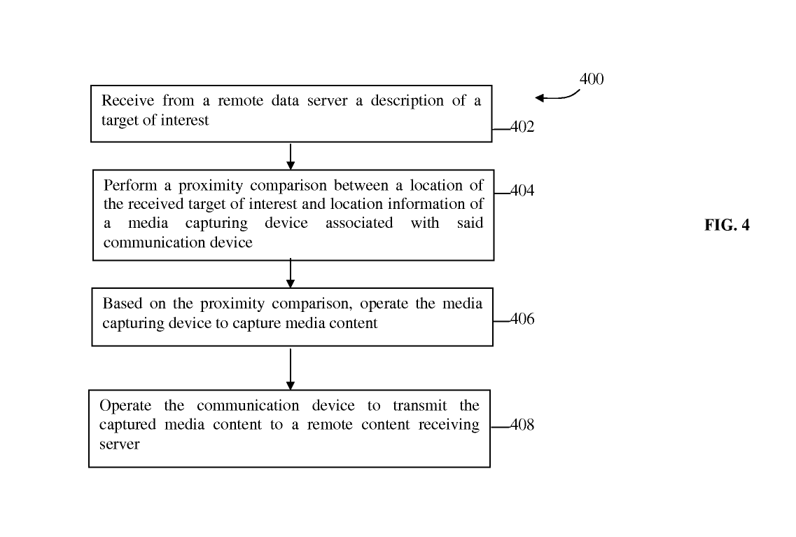

FIG. 4 is a flowchart of a method, according to embodiments of the invention. In operation 402, a processor associated with a communication device, such as a mobile phone or smart phone, may receive from a remote data server a description of a target of interest. The target of interest may include information on a newsworthy event, for example, and include the location, time, and desired media footage of the event. In operation 404, the processor may perform a proximity comparison between a location of the received target of interest and location information of a media capturing device associated with said communication device. The proximity comparison may be a determination of distance between the locations or time to travel from the location of the device to the target of interest. The proximity comparison may factor traffic, for example, as part of its determination. In operation 406, based on the proximity comparison, for example, if the processor determines that the communication device is near the target of interest, the processor may operate the media capturing device to capture media content onto a recording device, for example, or streamed directly to a server. The recording device may be part of the communication device or may be controllable by the communication device. In operation 408, the processor may transmit the captured media content to a remote content receiving server. The remote content receiving server may be controlled, operated, or accessible by a content publisher. The content publisher then may store, edit, and broadcast the received media content.

While the invention has been described with respect to a limited number of embodiments, these should not be construed as limitations on the scope of the invention, but rather as exemplifications of some of the preferred embodiments. Other possible variations, modifications, and applications are also within the scope of the invention. Different embodiments are disclosed herein. Features of certain embodiments may be combined with features of other embodiments; thus certain embodiments may be combinations of features of multiple embodiments.

What is claimed is:

1. A non-volatile computer readable medium having stored thereon a set of instructions that when executed by a processor associated with a communication device causes the processor to:
receive from a remote data server a description of a target of interest;
perform a proximity comparison between a location of the received target of interest and location information of a media capturing device associated with said communication device;
based on the proximity comparison, operate the media capturing device to capture media content; and
operate the communication device to transmit the captured media content to a remote content receiving server.

2. The non-volatile computer readable medium of claim 1, wherein said set of instructions further cause the processor to:
based on the proximity comparison, notify a user of the communication device to said capturing of media content or said transmitting of the captured media content.

3. The non-volatile computer readable medium of claim 2, wherein the processor is to notify a user of the communication device by requesting permission from the user to operate the recording device to capture media content.

4. The non-volatile computer readable medium of claim 2, wherein the processor is to notify a user of the communication device by requesting permission from the user to transmit the captured media content.

5. The non-volatile computer readable medium of claim 1, wherein said set of instructions further cause the processor to request from the user of the communication device permission to transmit the location information of the communication device to the remote server.

6. The non-volatile computer readable medium of claim 1, wherein said set of instructions further cause the processor to encode and compress the captured media content prior to transmitting.

7. The non-volatile computer readable medium of claim 1, wherein said set of instructions further cause the processor to:
transmit the location of the communication device to the remote server; and
based on the transmitted location, receive a request for content from the remote server related to the target of interest.

8. The non-volatile computer readable medium of claim 1, wherein the media capturing device is integrated with the communication device on one device.

9. A content solicitation method, comprising:
receiving from a remote data server a description of a target of interest;
performing, by a processor of a communication device, a proximity comparison between a location of the received target of interest and location information of a media capturing device associated with the communication device;
based on the proximity comparison, operating the media capturing device to capture media content; and
operating the communication device to transmit the captured media content to a remote content receiving server.

10. The content solicitation method of claim 9, comprising:
based on the proximity comparison, notifying a user of the communication device of said capturing of media content or said transmitting of the captured media content.

11. The content solicitation method of claim 10, wherein notifying a user comprises requesting permission from the user to operate the recording device to capture media content.

12. The content solicitation method of claim 10, wherein notifying a user comprises requesting permission from the user to transmit the captured media content.

13. The content solicitation method of claim 9, comprising requesting from the user of the communication device permission to transmit the location of the communication device to the remote server.

14. The content solicitation method of claim 9, comprising encoding and compressing the captured media content prior to transmitting.

15. The content solicitation method of claim 9, comprising:
transmitting the location of the communication device to the remote server; and
based on the transmitted location, receiving a request for content from the remote server related to the target of interest

16. A content solicitation method, comprising:
selecting, by a server, at least one remote communication device according to at least one of: last known location of said device, estimated location of said device, content capturing properties of said device, user profile, device profile, or transmission properties of said device; and
capturing, by the selected remote communication device, media content onto a recording interface;
transmitting, by the selected remote communication device, the captured media content to a content server.

17. The content solicitation method of claim 16, comprising notifying the selected remote communication device of said capturing of media content and said transmitting of captured media content.

18. The content solicitation method of claim 17, wherein notifying the selected remote communication device comprises requesting permission from the selected communication device to capture media content.

19. The content solicitation method of claim 16, notifying the selected remote communication device comprises requesting permission from the selected communication device to transmit the captured media content to a content server.

20. The content solicitation method of claim 16, comprising transmitting a location of at least one remote communication device to the server.
